(19) United States
(12) Patent Application Publication
(10) Pub. No.: US 2016/0117705 A1
(43) Pub. Date: Apr. 28, 2016

(54) METHOD AND SYSTEM FOR IDENTIFYING FUTURE MOVEMENT BASED ON PAST TRANSACTIONS

(71) Applicant: MasterCard International Incorporated, Purchase, NY (US)

(72) Inventors: Andrew A. ROBINSON, Doncaster (GB); John Trencher, Loughborough (GB)

(73) Assignee: MASTERCARD INTERNATIONAL INCORPORATED, Purchase, NY (US)

(21) Appl. No.: 14/524,363

(22) Filed: Oct. 27, 2014

(51) Int. Cl. G06Q 30/02

(52) U.S. Cl. CPC G06Q 30/0205

(57) ABSTRACT

A method for generating consumer travel paths based on transaction history includes: storing transaction data for a plurality of payment transactions, the data including a geographic location, transaction time and/or date, and consumer identifier; receiving a specific geographic area for which movement is requested; identifying a payment transaction set that includes transaction data for a set of payment transactions that include a common consumer identifier, a geographic location corresponding to the received specific geographic area, and a transaction time and/or date included within a predetermined period of time; generating a travel path based on at least the geographic location and transaction time and/or date included in the transaction data for each payment transaction included in the payment transaction set; and predicting a future travel path based on at least the generated travel path.

### FIELD

The present disclosure relates to the generating and consumer travel paths and identification of consumer trip patterns, specifically the use of historical and current transaction data for a consumer to identify current travel paths and predict future travel paths of the consumer.

### BACKGROUND

Merchants, advertisers, content providers, and other entities can often find a lot of value in learning everything that they can about consumers. Learning of a consumer's shopping habits, interests, brand or product preferences, likes, dislikes, etc. can be beneficial in terms of improving the targeting of advertisements, offers, and other content distributed to the consumer. For example, if a department store learns that a consumer likes to buy movies, and in particular action movies, then advertisements sent to the consumer can feature action movies that are on sale, which may result in more effective advertising and increased revenue for the merchant.

Another piece of data that merchants and other entities can often find value in for consumers is their location and traveling habits. By learning where a consumer has gone, entities can identify where the consumer might go in the future, and target the distribution of content accordingly. For example, if an advertiser learns that a consumer always visits a coffee shop after going to a grocery store, the advertiser may advertise coffee to the consumer at the checkout of the grocery store or once leaving the store. This data can also be beneficial for property managers, real estate developers, and other similar entities in the placement of stores, properties, advertisements, transportation, etc.

Traditional methods for identifying a consumer's location often include tracking the geolocation of a mobile device, such as a cellular phone, associated with the consumer. Because consumers often possess their mobile device, such data can provide an in-depth map of a consumer's movement. However, there are often a number of problems that make mobile devices unsuitable for use in identifying consumer location and traveling patterns. For example, consumers may not have a mobile device whose location can be tracked, consumers may turn off location services that enable tracking, consumers may not take their mobile device with them when they go to shop or leave their mobile device in a vehicle as they walk to multiple locations, mobile devices may run out of battery and cease transmission, mobile devices may lose service and make tracking unavailable, etc.

Thus, there is a need for a technical solution to be able to identify a consumer's traveling path and predict future travel paths and trip patterns for a consumer that does not rely on a consumer's mobile device.

### SUMMARY

The present disclosure provides a description of systems and methods for identifying consumer travel paths and trip patterns based on transaction history.

A method for generating consumer travel paths based on transaction history includes: storing, in a transaction database, transaction data for a plurality of payment transactions, wherein the transaction data includes at least a geographic location and transaction time and/or date associated with the respective payment transaction and an consumer identifier associated with a consumer involved in the respective payment transaction; receiving, by a receiving device, a specific geographic area for which consumer movement is requested; identifying, by a processing device, a payment transaction set for each of one or more consumers, wherein each payment transaction set includes transaction data for a set of payment transactions that include a common consumer identifier, a geographic location corresponding to the received specific geographic area, and a transaction time and/or date included within a predetermined period of time; generating, by the processing device, a travel path for each payment transaction set that identifies movement of a consumer associated with the common consumer identifier for the respective payment transaction set, wherein the travel path is based on at least the geographic location and transaction time and/or date included in the transaction data for each payment transaction included in the respective payment transaction set; and predicting, by the processing device, a future travel path for each payment transaction set that predicts future movement of the consumer associated with the common consumer identifier for the respective payment transaction set, wherein the future travel path is based on at least the generated travel path.

A method for identifying consumer trip patterns includes: storing, in a transaction database, transaction data for a plurality of payment transactions, wherein the transaction data includes at least a geographic location and transaction time and/or date associated with the respective payment transaction and an consumer identifier associated with a consumer involved in the respective payment transaction; receiving, by a receiving device, a specific consumer identifier; identifying, by a processing device, transaction data for a subset of payment transactions, wherein the transaction data for each payment transaction in the subset includes a consumer identifier that corresponds to the received specific consumer identifier; identifying, by the processing device, a plurality of transaction sets, wherein each transaction set includes transaction data for a payment transaction in the subset of payment transaction where the included transaction time and/or date is within one of a plurality of periods of time; generating, by the processing device, a travel path for each transaction set that identifies movement of a consumer associated with the specific consumer identifier, wherein the travel path is based on at least the geographic location and transaction time and/or date included in the transaction data for each payment transaction included in the respective transaction set; and identifying, by the processing device, one or more trip patterns for the consumer associated with the specific consumer identifier, wherein each trip pattern is based on correspondence between the generated travel path and associated period of time for each transaction set.

A system for generating consumer travel paths based on transaction history includes a transaction database, a receiving device, and a processing device. The transaction database is configured to store transaction data for a plurality of payment transactions, wherein the transaction data includes at least a geographic location and transaction time and/or date associated with the respective payment transaction and an consumer identifier associated with a consumer involved in the respective payment transaction. The receiving device is configured to receive a specific geographic area for which consumer movement is requested. The processing device is configured to: identify a payment transaction set for each of one or more consumers, wherein each payment transaction set includes transaction data for a set of payment transactions that include a common consumer identifier, a geographic location corresponding to the received specific geographic area, and a transaction time and/or date included within a predetermined period of time; generate a travel path for each payment transaction set that identifies movement of a consumer associated with the common consumer identifier for the respective payment transaction set, wherein the travel path is based on at least the geographic location and transaction time and/or date included in the transaction data for each payment transaction included in the respective payment transaction set; and predict a future travel path for each payment transaction set that predicts future movement of the consumer associated with the common consumer identifier for the respective payment transaction set, wherein the future travel path is based on at least the generated travel path.

A system for identifying consumer trip patterns includes a transaction database, a receiving device, and a processing device. The transaction database is configured to store transaction data for a plurality of payment transactions, wherein the transaction data includes at least a geographic location and transaction time and/or date associated with the respective payment transaction and an consumer identifier associated with a consumer involved in the respective payment transaction. The receiving device is configured to receive a specific consumer identifier. The processing device is configured to: identify transaction data for a subset of payment transactions, wherein the transaction data for each payment transaction in the subset includes a consumer identifier that corresponds to the received specific consumer identifier; identify a plurality of transaction sets, wherein each transaction set includes transaction data for a payment transaction in the subset of payment transaction where the included transaction time and/or date is within one of a plurality of periods of time; generate a travel path for each transaction set that identifies movement of a consumer associated with the specific consumer identifier, wherein the travel path is based on at least the geographic location and transaction time and/or date included in the transaction data for each payment transaction included in the respective transaction set; and identify one or more trip patterns for the consumer associated with the specific consumer identifier, wherein each trip pattern is based on correspondence between the generated travel path and associated period of time for each transaction set.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for generating consumer travel paths and trip patterns using transaction history in accordance with exemplary embodiments.

FIG. 2 is a block diagram illustrating the processing server of FIG. 1 for the identification of consumer travel paths and trip patterns in accordance with exemplary embodiments.

FIG. 3 is a block diagram illustrating the transaction database of the processing server of FIG. 2 for storing transaction data in accordance with exemplary embodiments.

FIG. 4 is a flow diagram illustrating a process for predicting a consumer's future travel path based on transaction history in accordance with exemplary embodiments.

FIG. 5 is a diagram illustrating a consumer travel path based on transaction history and prediction of a future travel path based thereon in accordance with exemplary embodiments.

FIG. 6 is a flow chart illustrating an exemplary method for generating consumer travel paths based on transaction history in accordance with exemplary embodiments.

FIG. 7 is a flow chart illustrating an exemplary method for identifying consumer trip patterns in accordance with exemplary embodiments.

FIG. 8 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

### System for Identifying Consumer Travel Paths and Trip Patterns

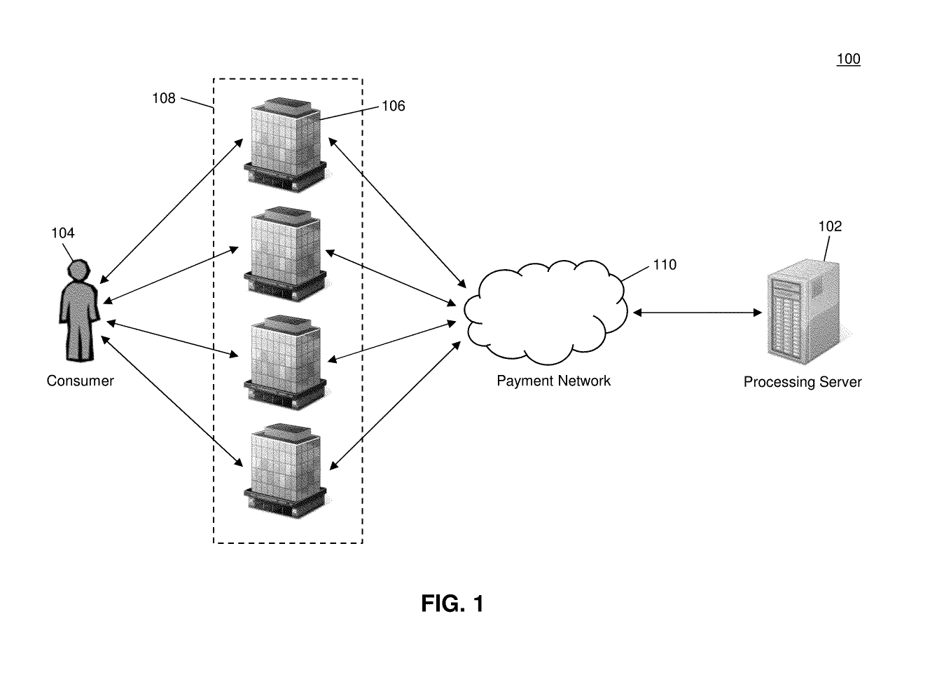

FIG. 1 illustrates a system 100 for identifying consumer travel paths and trip patterns based on consumer transaction history.

The system 100 may include a processing server 102. The processing server 102, discussed in more detail below, may be configured to identify travel paths and trip patterns based on transaction history and predict future travel paths and trips based thereon. A consumer 104 may conduct payment transactions with a plurality of merchants 106. Each merchant 106 may be located in a geographic area 108. The geographic area 108 may be a shopping mall, airport, transportation center, stadium or arena, event location, city, municipality, or any other geographic area suitable for performing the functions disclosed herein as will be apparent to persons having skill in the relevant art.

The consumer 104 may travel from merchant 106 to merchant 106 in the geographic area 108 and conduct payment transactions. Each payment transaction may be processed by a payment network 110 using methods and systems that will be apparent to persons having skill in the relevant art. The payment network 110 may process the payment transactions, and may transmit transaction data for the payment transactions to the processing server 102. In some embodiments, the processing server 102 may be a part of the payment network 110 and receive the transaction data based on the processing conducted therein. In further embodiments, the processing server 102 may be configured to process the payment transactions.

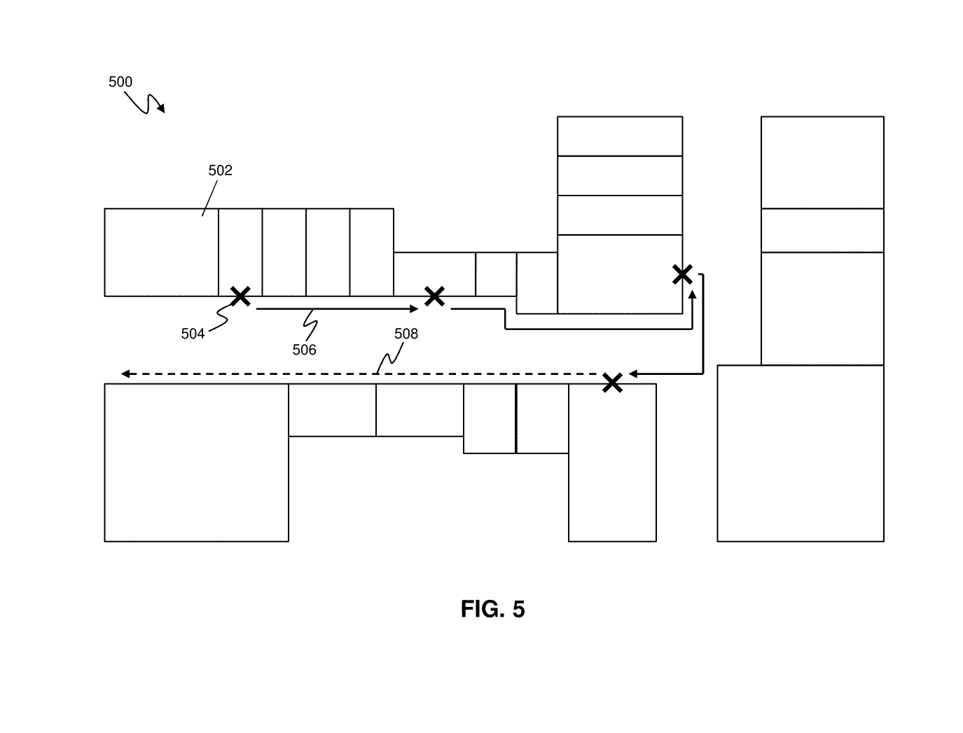

Based on times of the payment transactions and the geographic locations of the merchants 106, the processing server 102 may identify a travel path for the consumer 104. The processing server 102 may also be configured to predict a future travel path for the consumer 104 based on the identified travel path. An illustrated example of the identification of a travel path and prediction of a future travel path can be found in FIG. 5, discussed in more detail below.

In some embodiments, the processing server 102 may be configured to identify one or more merchants 106 on the predicted travel path of the consumer 104. The processing server 102 may notify the merchants 106 that the consumer 104 is predicted to visit their location. The merchants 106 can then prepare advertisements or offers, or may actively encourage the consumer 104 to visit their location with advertisements or offers knowing that the consumer 104 is likely to be passing by already. In some embodiments, the processing server 102 may identify advertisements, offers, or other content based on the predicted future travel path and transmit them to the consumer 104 itself. For instance, the processing server 102 may transmit content to a mobile device associated with the consumer 104, such as a cellular phone, smart phone, tablet computer, smart watch, etc., may cause a display on the predicted travel path to display the content, or use another suitable method that will be apparent to persons having skill in the relevant art.

The use of transaction history to identify travel paths and predict future travel paths can enable the processing server 102 to provide accurate and reliable travel information for a consumer 104 that can be impossible in traditional systems that rely on mobile device geolocation. In addition to an increase in reliability offered by using transaction history rather than other methods for identifying the consumer's 104 location, the processing server 102 may be more effective in identifying consumer travel paths that have a higher effectiveness for advertisers and content providers, as the consumer 104 is actively engaged in purchasing at the time. This can reduce the number of instances where an advertiser or merchant may be notified of a consumer traveling to their location that may be uninterested in shopping, such as a consumer 104 passing by or going to work, which can occur using traditional systems. As a result, the systems and methods of the processing server 102 discussed herein can result in a more effective and reliable identification of consumer travel paths.

In addition to identifying a travel path and predicting a future travel path based on payment transactions that are occurring at or near the present in or near real-time, the processing server 102 may also be configured to identify trip patterns. Trip patterns may be identified by analyzing travel paths for the consumer 104 over a period of time. For example, the processing server 102 may identify that the consumer 104 goes grocery shopping at a specific grocery store every Wednesday morning, goes out to dinner in a specific general area every Friday night, and goes to lunch in a specific general area and then a specific coffee shop every weekday.

The trip patterns may be used by the processing server 102 as, or in the determination of, predicted future travel paths of the consumer 104. For instance, before the consumer's 104 usual grocery shopping time on Wednesday mornings, the processing server 102 may identify a future travel path for the consumer 104 to the grocery store. In another example, once the consumer 104 has purchased their lunch on a weekday, the processing server 102 may predict a travel path that takes the consumer 104 from the merchant 106 with whom they had lunch to the coffee shop the consumer 104 always visits. Thus, the processing server 102 may predict future travel paths solely based on the identified trip patterns, or may use the trip patterns in addition to the present transaction history in the prediction of a future travel path.

The identification and use thereof of trip patterns by the processing server 102 may also enable the processing server 102 to provide stronger, more accurate predictions of travel paths for a consumer 104 than may be available using traditional systems. In traditional systems, historical location data from mobile devices may be unable, may not be stored, or may not be reliable. In addition, as noted above, may include instances where a consumer 104 is not shopping and may miss instances where a consumer 104 is shopping, such as due to bad service, being left at home, etc. Thus, the processing server 102 can provide for more effective predictions by using transaction history for known transactions.

Additional uses of consumer travel path and trip pattern data will be apparent to persons having skill in the relevant art. For instance, a merchant wanting to open a new location in a shopping mall may analyze consumer travel path data to identify an optimal location for the new store, such as at a location that is most frequently passed by consumers that travel through the mall. In another example, consumer trip patterns that always take consumers by a certain geographic location on frequent trips may be a suitable location for a new store for a merchant.

### Processing Server

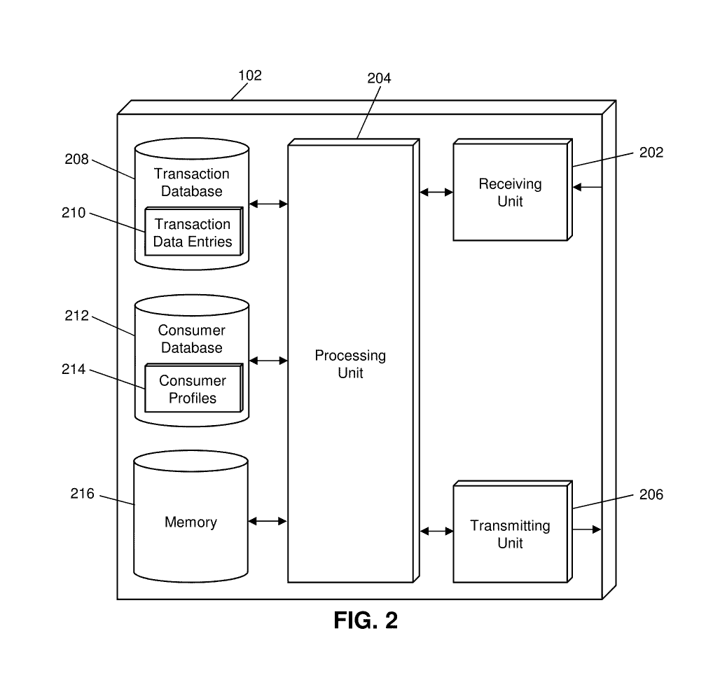

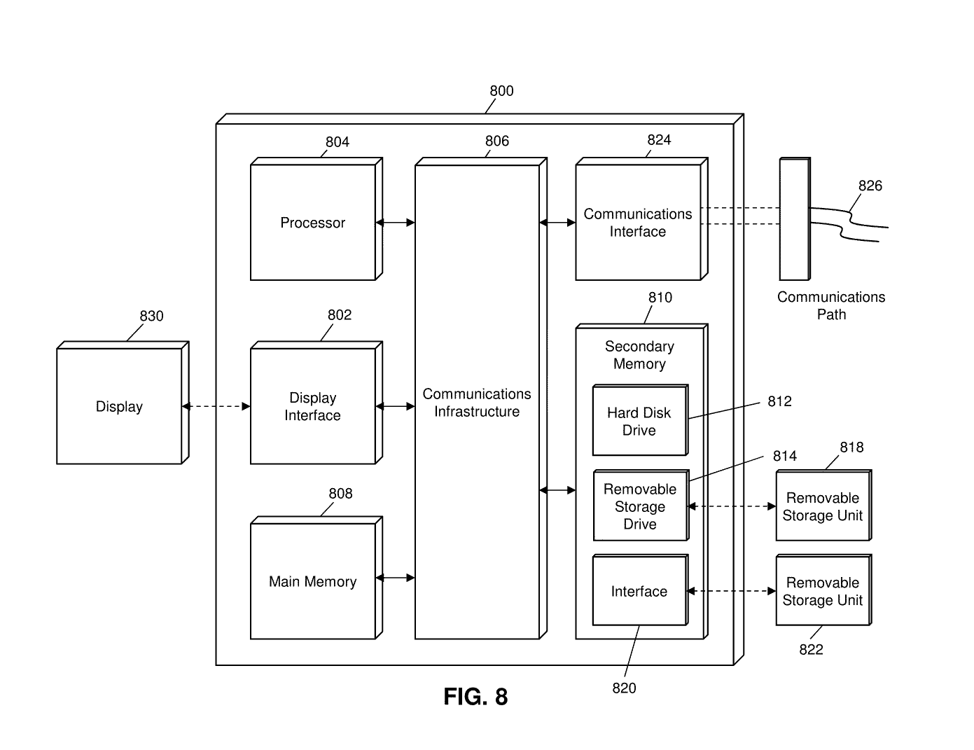

FIG. 2 illustrates an embodiment of the processing server 102 of the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 8 illustrated in FIG. 8 and discussed in more detail below may be a suitable configuration of the processing server 102.

The processing server 102 may include a receiving unit 202. The receiving unit 202 may be configured to receive data over one or more networks via one or more network protocols. The receiving unit 202 may receive transaction data for a plurality of payment transactions involving consumers 104 from the payment network 110. The payment transactions may be stored in a transaction database 208 in a plurality of transaction data entries 210, discussed in more detail below. The receiving unit 202 may also be configured to receive requests for travel paths or trip patterns, content to be distributed, and other data.

The processing server 102 may also include a processing unit 204. The processing unit 204 may be configured to perform the functions of the processing server 102 as discussed herein as will be apparent to persons having skill in the relevant art. The processing unit 204 may be configured to identify transaction data stored in the transaction database 208 for payment transactions that involve a single consumer 104. The processing unit 204 may then identify a travel path for the consumer 104 based on times and/or dates for the payment transactions and geographic locations. In some instances, the processing unit 204 may identify a plurality of travel paths, such as based on predetermined periods of time. For example, the processing unit 204 may separate transactions for travel paths based on day, if there is a specific amount of time between transactions (e.g., three or more hours), etc.

In some embodiments, the processing unit 204 may be configured to identify a travel path for a plurality of consumers 104. For instance, each transaction data entry 210 may be associated with a group of consumers 104, such as a microsegment of consumers. In such an instance, a travel path may be identified for the group of consumers 104 such as it may apply to any consumer 104 in the group. As a result, travel paths identified for consumers in a group may not be personally attributable to any specific consumer 104 in the group. In other embodiments, consumer data associated with the transaction data entries 210 may be anonymized such that the consumer 104 with whom transaction data is applicable is not personally identifiable. For instance, consumer identifiers, discussed in more detail below, may be encrypted such that the associated consumer 104 is not personally identifiable. In some embodiments, a consumer 104 may provide consent for their transaction data to be obtained and used.

In instances where a plurality of travel paths may be identified for a consumer 104, the processing unit 204 may also be configured to identify a trip pattern. A trip pattern may be identified based on correspondence between the travel paths in a geographic area over multiple periods of time. For example, the processing unit 204 may identify a trip pattern if the consumer 104 has the same or a similar travel path during three different time periods that occur at the same or similar time of day, week, month, year, etc. For instance, the consumer 104 may make a yearly shopping trip along the same travel path the day after Thanksgiving, may make a monthly trip to a restaurant on the same day of the month, etc.

The processing unit 204 may be further configured to predict future travel paths. A future travel path may be predicted based on the consumer's 102 current travel path identified by the processing unit 204, and, if applicable, one or more trip patterns identified for the consumer 102. In some embodiments, the processing server 102 may also include a consumer database 212. The consumer database 212 may include a plurality of consumer profiles 214. Each consumer profile 214 may include data associated with a consumer 104 and/or a transaction account. The consumer profile 214 may be used to store travel path information, identified trip patterns, and other suitable data for use by the processing unit 204 in performing the functions disclosed herein. For instance, identified trip patterns and travel paths may be stored in the consumer profile 214 for a consumer 104 and used in predicting future travel paths.

The processing server 102 may also include a transmitting unit 206. The transmitting unit 206 may be configured to transmit data over one or more networks via one or more network protocols. The transmitting unit 206 may transmit predicted travel paths, trip patterns, and other suitable data to merchants, advertisers. In some embodiments, the data may be transmitted in response to a request received by the receiving unit 202. In some instances, the processing unit 204 may be configured to identify one or more merchants 106 whose geographic location matches to the predicted future travel path of the consumer 104. In such an instance, the transmitting unit 206 may transmit a notification to the merchants 106 indicating that the consumer 104 may be traveling their way.

In embodiments where the processing server 102 may receive content to transmit to consumers 104, the processing unit 204 may be configured to identify content for distribution to the consumer 104 based on at least the predicted future travel path. For example, the processing unit 204 may identify content associated with a geographic location along the predicted future travel path, and the transmitting unit 206 may transmit the identified content to the consumer 104. Methods and systems for identifying content based on an expected geographic location and transmission thereof will be apparent to persons having skill in the relevant art.

In some embodiments, the processing unit 204 may be further configured to classify consumers 104. In such an embodiment, the processing unit 204 may classify a consumer 104 based on their identified trip patterns. For instance, a consumer 104 may be grouped with other consumers 104 with similar trip patterns or with a same trip pattern. For example, consumers 104 that travel to the same area for dinner on Friday evenings may be grouped together. In some instances, a consumer 104 may be placed in multiple classifications. In one embodiment, classifications may include one or more microsegments, such as where consumers 104 may be classified with other consumers with similar demographic profiles. Classification data may be stored in the corresponding consumer profile 214 for a consumer 104, and may be transmitted by the transmitting unit 206. For example, information regarding a group of consumers 104 that have a specific trip pattern may be transmitted to a merchant 106 whose location corresponds to the trip pattern.

The processing server 102 may also include a memory 216. The memory 216 may be configured to store data for the processing server 102 suitable for performing the functions disclosed herein. For example, the memory 216 may be configured to store rules and/or algorithms for identifying travel paths, for predicting future travel paths, for identifying trip patterns, for identifying content to be distributed, etc., may store merchant geographic locations, algorithms for identifying merchants along a predicted future travel path, etc. Additional data stored in the memory 216 will be apparent to persons having skill in the relevant art.

### Transaction Database

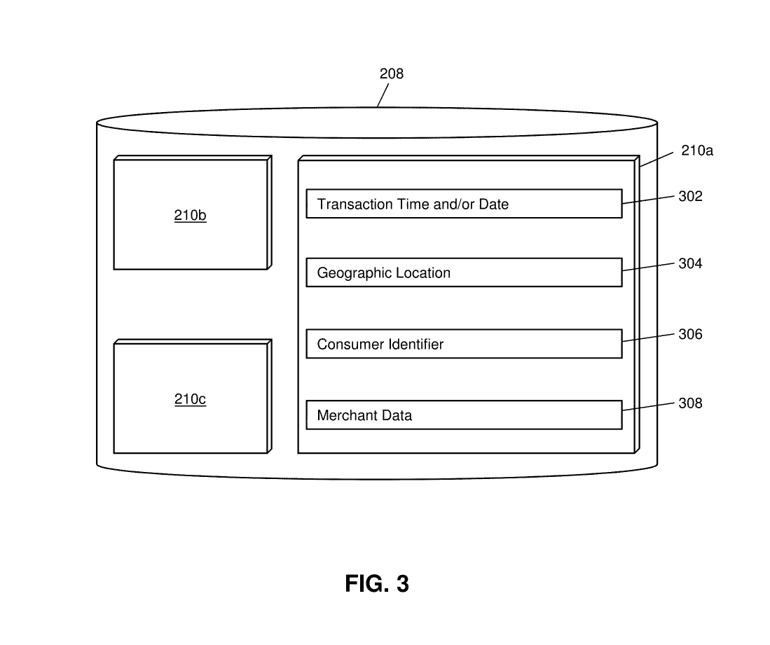

FIG. 3 illustrates the transaction database 208 of the processing server 102 for storing transaction history for consumers 104.

The transaction database 208 may include a plurality of transaction data entries 210, illustrated in FIG. 3 as transaction data entries 210a, 210b, and 210c. Each transaction data entry 210 may include at least a transaction time and/or date 302, a geographic location 304, and a consumer identifier 306. In some embodiments, transaction data entries 210 may also include merchant data 308.

The transaction time and/or date 302 may be the time and/or date at which the corresponding payment transaction was processed, which may be the time of generation of the authorization request, of submission of the authorization request, of receipt of approval of the payment transaction, of submission of an authorization response, or other suitable time during the processing of the payment transaction that will be apparent to persons having skill in the relevant art. The geographic location 304 may be the location of the payment transaction. The geographic location 304 may be encoded in the authorization request, may be a geographic location 304 associated with the merchant 106 involved in the payment transaction, or may be identified via or suitable method. The geographic location 304 may be represented as latitude and longitude, a street address, or other suitable representation.

The consumer identifier 306 may be a unique value associated with the consumer 104 and/or transaction account involved in the payment transaction. The consumer identifier 306 may be an identification number, transaction account number, username, e-mail address, phone number, or other suitable value that will be apparent to persons having skill in the relevant art. In some instances, the consumer identifier 306 may be associated with a group of consumers, such as a microsegment.

In some embodiments, the consumer identifier 306 may be encrypted, hashed, or otherwise anonymized such that it is not personally identifiable to the associated consumer 104. For instance, a transaction account number may be encrypted via a one-way encryption and used by the processing server 102 so that the associated transaction data cannot be associated with the actual transaction account. In such an instance, travel path or trip pattern data may be transmitted to an authorized third party using the encrypted transaction account number, which may be matched to the actual transaction account by the authorized third party. As a result, the processing server 102 may not possess personally identifiable information.

The merchant data 308 may include data associated with a merchant 106 involved in the related payment transaction. For instance, the merchant data 308 may include a merchant identifier, merchant identification number, geographic location, point of sale data, merchant name, merchant description, merchant industry, etc. In some embodiments, each transaction data entry 210 may also include additional transaction data, such as a transaction amount, product data, offer data, loyalty data, and additional data that will be apparent to persons having skill in the relevant art.

### Process for Identifying Travel Paths

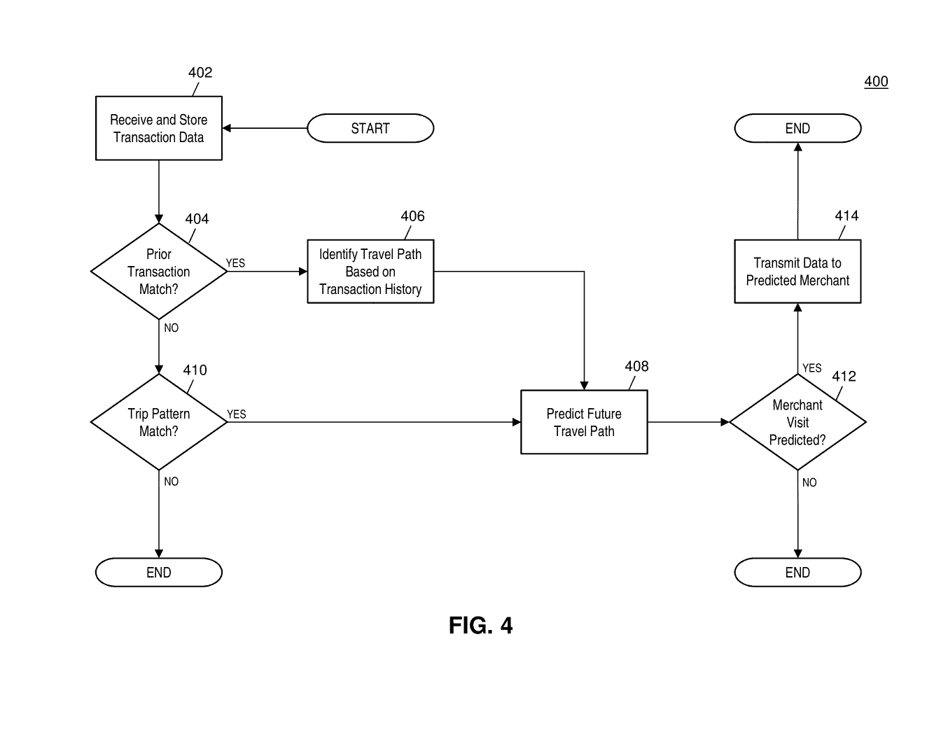

FIG. 4 illustrates a process 400 for the identification of a consumer travel path based on transaction history.

In step 402, the receiving unit 202 of the processing server 102 may receive transaction data for a payment transaction from the payment network 110. The processing unit 204 of the processing server 102 may store the transaction data in a transaction data entry 210 in the transaction database 208 of the processing server 102. The transaction data may include at least a transaction time and/or date 302, a geographic location 304, and a consumer identifier 306.

In step 404, the processing unit 204 may determine if there is another payment transaction that matches the payment transaction for which data was received. A payment transaction may match if its respective transaction data entry 210 includes the same consumer identifier 306 and its transaction time and/or date is within a predetermined period of time of the transaction time and/or date in the received transaction data. For example, the predetermined period of time may be one hour. In some embodiments, a matching payment transaction may have a geographic location 304 within a predetermined distance from the received payment transaction or in a specific geographic area 108 that also includes the received payment transaction. For example, a geographic location 304 in the same shopping mall 108 as the received payment transaction. In some instances, the processing unit 204 may identify a plurality of matched transactions, such as indicating multiple purchases in the same shopping trip.

If there is at least one matching transaction, then in step 406, the processing unit 204 may identify a travel path based on the transaction times and/or dates 302 and geographic locations 304 of each of the transactions. In step 408, the processing unit 204 may predict the future travel path for the consumer 104 based on the identified travel path. In some embodiments, the future travel path may also be based on one or more trip patterns associated with the consumer 104, such as in a consumer profile 214 in the consumer database 212 that includes the same consumer identifier included in the received transaction data.

If, in step 404, no matching transaction data was found, then, in step 410, the processing unit 204 may determine if there was a trip pattern that matched the geographic location 304 and transaction time and/or date 302 in the received transaction data. For example, if the trip pattern is for Wednesday morning grocery shopping and the payment transaction is on a Wednesday morning and at a grocery store. If there is no trip pattern match, then the process 400 may be completed. In such an instance, the consumer 104 may not be on a shopping trip, or the processing server 102 may wait for additional data for a stronger identification of the consumer's 104 travel path.

If there is a trip pattern match, then the process 400 may proceed to step 408 where the future travel path of the consumer 104 is predicted by the processing unit 204. As discussed above, the future travel path may be based on the geographic location 304 of the received payment transaction and the data associated with the matching trip pattern. For example, if a trip pattern identifies that the consumer 104 always goes to lunch and then a coffee shop, and the received payment transaction is for lunch, then the future travel path may be to the coffee shop.

Once a future travel path has been predicted, then, in step 412, the processing unit 204 may determine if the consumer 104 will visit one or more particular merchants 106 in their future travel. The determination may be based on the predicted future travel path and a geographic location stored for each of the merchants 106, such as in the memory 216. If the consumer's 104 travel path does not take them to any of the merchants 106, such as because the consumer 104 has determined to be traveling home, then the process 400 may be completed. If the consumer 104 will be passing by and/or visiting at least one of the merchants 106, then, in step 414, the transmitting unit 206 of the processing server 102 may transmit data to the appropriate merchant(s) 106. The data may include data associated with the consumer 104, such as the consumer identifier 306 or any other consumer data, such as data provided by the consumer 104 (e.g., consumer preferences, brand preferences, product preferences, offer preferences, etc.), purchase behaviors (e.g., propensities for the consumer 104 to purchase based on the transaction data), etc.

### Prediction of a Future Travel Path

FIG. 5 illustrates the identification of a travel path based on transaction history and the prediction of a future travel path.

FIG. 5 illustrates a shopping mall 500. The shopping mall 500 may be a geographic area 108 that includes a plurality of merchants 106, illustrated in FIG. 5 as merchants 502. Each merchant 502 may be located in the shopping mall 500 at the geographic location represented by its corresponding rectangle, which may correspond to the physical bounds of the merchant property.

A consumer 104 may visit a plurality of the merchants 502 and may conduct payment transactions at some of the merchants 502. Each payment transaction may be processed by the payment network 110 and corresponding transaction data sent to the processing server 102. The transaction data may include a geographic location 504. Each of the geographic locations 504 illustrated in the shopping mall 500 may thereby be indicative of a merchant 502 with whom the consumer 104 transacted.

The processing unit 204 of the processing server 102 may be configured to identify a travel path 506 for the consumer 104. The travel path 506 may be based on the geographic location 504 for each of the transactions, as well as the transaction time and/or date 302 for each of the transactions. The arrows included on the travel path 506 indicate the direction of the travel by the consumer 104 from one geographic location 504 to the next based on the transaction times and/or dates 302. In the example illustrated in FIG. 5, the consumer 104 may travel from one end of the shopping mall 500 toward the other for three payment transactions, and then cut back for a fourth.

The processing unit 204 may then predict a future travel path 508 for the consumer 102. The future travel path 508 may be predicted based on the identified travel path 506. Because the consumer 104 started at the left end of the shopping mall 500, and because after the consumer's 104 third payment transaction they started back towards that end, the processing unit 204 may determine that the consumer 102 is returning to the left end of the shopping mall 500 where the travel path 506 had started, such as to return to their vehicle or mode of transportation. The processing unit 204 can then identify any of the merchants 502 along the consumer's 104 predicted future travel path 508 to notify them of the consumer 104, transmit offers corresponding to the merchants 502 to the consumer 104, etc.

### Exemplary Method for Generating Consumer Travel Paths

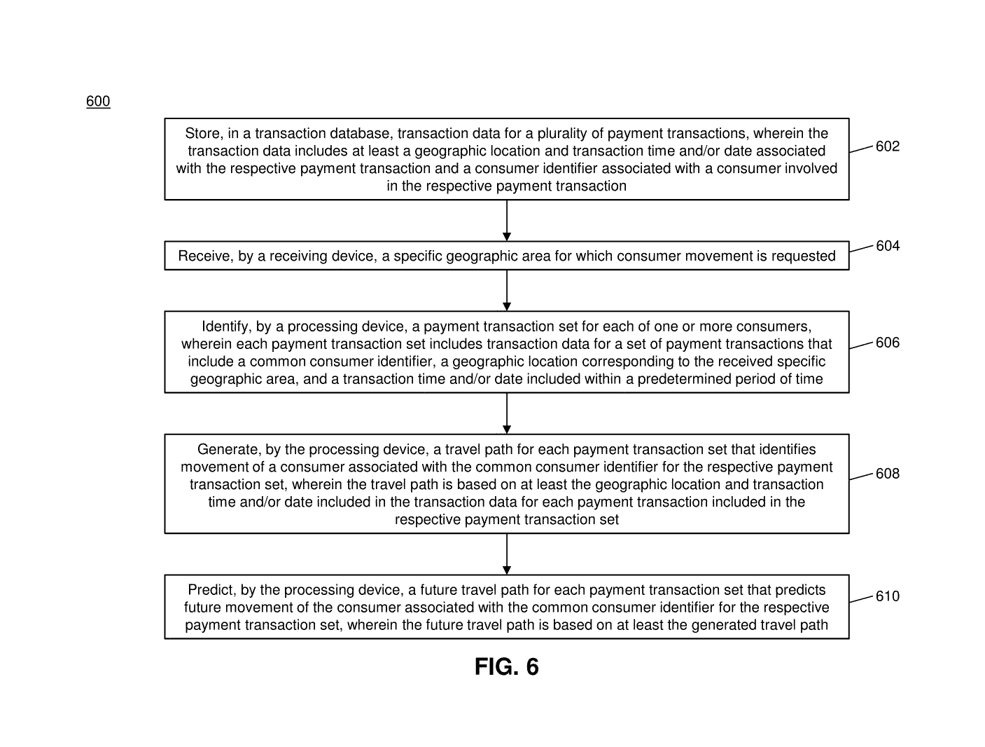

FIG. 6 illustrates a method 600 for generating consumer travel paths based on transaction history.

In step 602, transaction data for a plurality of payment transactions may be stored in a transaction database (e.g., the transaction database 208), wherein the transaction data includes at least a geographic location (e.g., geographic location 304) and transaction time and/or date (e.g., transaction time and/or date 302) associated with the respective payment transaction and a consumer identifier (e.g., consumer identifier 306) associated with a consumer (e.g., the consumer 104) involved in the respective payment transaction. In step 604, a specific geographic area (e.g., geographic area 108) may be received by a receiving device (e.g., the receiving unit 202) for which consumer movement is requested.

In step 606, a payment transaction set may be identified by a processing device (e.g., the processing unit 204) foe each of one or more consumers 104, wherein each payment transaction set includes transaction data for a set of payment transactions that include a common consumer identifier 306, a geographic location 304 corresponds to the received specific geographic area 108, and a transaction time and/or date 302 included within a predetermined period of time. In step 608, a travel path (e.g., travel path 506) may be generated by the processing device 204 for each payment transaction set that identifies movement of a consumer 104 associated with the common consumer identifier 306 for the respective payment transaction set, wherein the travel path 506 is based on at least the geographic location 304 and transaction time and/or date 302 included in the transaction data for each payment transaction included in the respective payment transaction set.

In step 610, a future travel path (e.g., future travel path 508) may be predicted by the processing device 204 for each payment transaction set that predicts future movement of the consumer 104 associated with the common consumer identifier 306 for the respective payment transaction set, wherein the future travel path 508 is based on at least the generated travel path 506. In one embodiment, the method 600 may also include identifying, by the processing device 204, an optimal location of a merchant within the specific geographic area 108 based on at least the generated travel path and predicted future travel path for each payment transaction set.

In some embodiments, predicting the future travel path 508 may include predicting a future geographic location that the consumer 104 is predicted to visit, and wherein the future geographic location corresponds to a geographic location of a merchant (e.g., merchant 106) located in the specific geographic area 108. In a further embodiments, the method 600 may also include transmitting, by a transmitting device (e.g., the transmitting unit 206), the predicted future travel path 508 for each payment transaction set. In an even further embodiment, the predicted future travel path 508 for each payment transaction set is transmitted to one or more merchants 106 having geographic locations that correspond to the predicted future travel path 508 for each payment transaction set.

### Exemplary Method for Identifying Consumer Trip Patterns

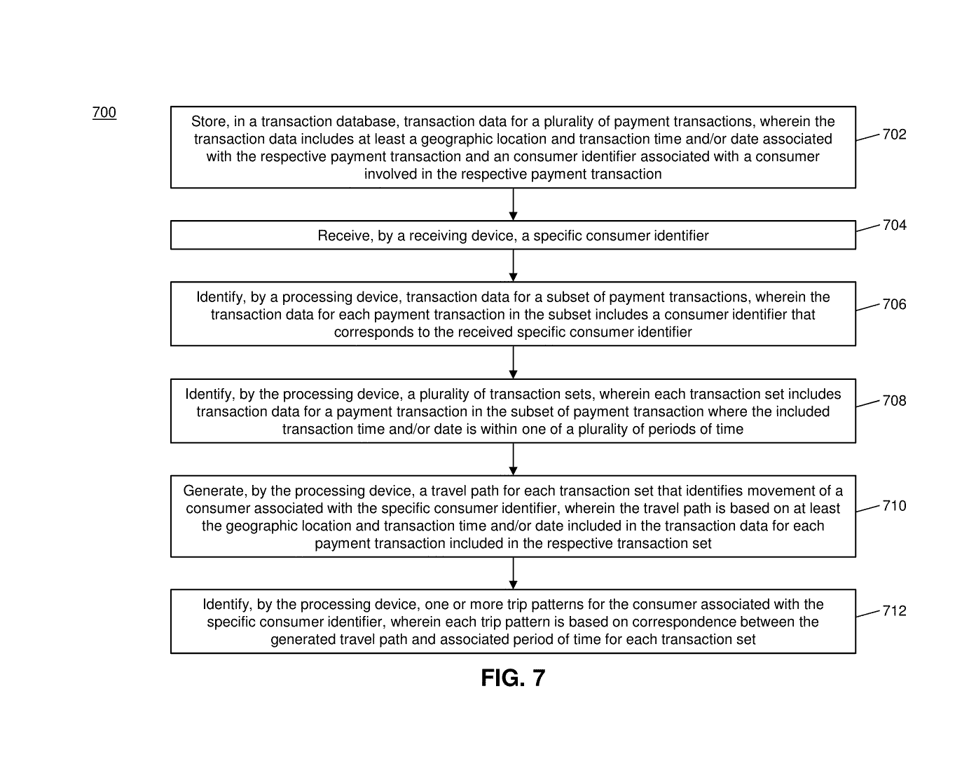

FIG. 7 illustrates a method 700 for identifying consumer trip patterns based on consumer travel paths and transaction history.

In step 702, transaction data for a plurality of payment transactions may be stored in a transaction database (e.g., the transaction database 208), wherein the transaction data includes at least a geographic location (e.g., geographic location 304) and transaction time and/or date (e.g., transaction time and/or date 302) associated with the respective payment transaction and a consumer identifier (e.g., consumer identifier 306) associated with a consumer (e.g., the consumer 104) involved in the respective payment transaction. In step 704, a specific consumer identifier may be received by a receiving device (e.g., the receiving unit 202).

In step 706, transaction data for a subset of payment transactions may be identified by a processing device (e.g., the processing unit 204), wherein the transaction data for each payment transaction in the subset includes a consumer identifier 306 that corresponds to the received specific consumer identifier. In step 708, a plurality of transaction sets may be identified by the processing device 204, wherein each transaction set includes transaction data for a payment transaction in the subset of payment transactions where the included transaction time and/or date 302 is within one of a plurality of periods of time.

In step 710, a travel path (e.g., the travel path 506) may be generated by the processing device 204 for each transaction set that identifies movement of a consumer (e.g., the consumer 104) associated with the specific consumer identifier, wherein the travel path 506 is based on at least the geographic location 304 and transaction time and/or date 302 included in the transaction data for each payment transaction included in the respective transaction set. In step 712, one or more trip patterns may be identified for the consumer 104 associated with the specific consumer identifier by the processing device 204, wherein each trip pattern is based on correspondence between the generated travel path 506 and associated period of time for each transaction set. In one embodiment, the method 700 may further include transmitting, by a transmitting device (e.g., the transmitting unit 202), the identified one or more trip patterns.

In some embodiments, the method 700 may also include classifying, by the processing device 204, the consumer 104 associated with the specific consumer identifier in at least one of a plurality of consumer classifications based on the identified one or more trip patterns. In a further embodiment, the method 700 may even further include transmitting the at least one consumer classification in which the consumer 104 is classified by the transmitting device 206. In another further embodiment, the plurality of consumer classifications may include one or more microsegments.

### Computer System Architecture

FIG. 8 illustrates a computer system 800 in which embodiments of the present disclosure, or portions thereof, may be implemented as computer-readable code. For example, the processing server 102 of FIG. 1 may be implemented in the computer system 800 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 4, 6, and 7.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 818, a removable storage unit 822, and a hard disk installed in hard disk drive 812.

Various embodiments of the present disclosure are described in terms of this example computer system 800. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 804 may be a special purpose or a general purpose processor device. The processor device 804 may be connected to a communications infrastructure 806, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 800 may also include a main memory 808 (e.g., random access memory, read-only memory, etc.), and may also include a secondary memory 810. The secondary memory 810 may include the hard disk drive 812 and a removable storage drive 814, such as a floppy disk drive, a magnetic tape drive, an optical disk drive, a flash memory, etc.

The removable storage drive 814 may read from and/or write to the removable storage unit 818 in a well-known manner. The removable storage unit 818 may include a removable storage media that may be read by and written to by the removable storage drive 814. For example, if the removable storage drive 814 is a floppy disk drive or universal serial bus port, the removable storage unit 818 may be a floppy disk or portable flash drive, respectively. In one embodiment, the removable storage unit 818 may be non-transitory computer readable recording media.

In some embodiments, the secondary memory 810 may include alternative means for allowing computer programs or other instructions to be loaded into the computer system 800, for example, the removable storage unit 822 and an interface 820. Examples of such means may include a program cartridge and cartridge interface (e.g., as found in video game systems), a removable memory chip (e.g., EEPROM, PROM, etc.) and associated socket, and other removable storage units 822 and interfaces 820 as will be apparent to persons having skill in the relevant art.

Data stored in the computer system 800 (e.g., in the main memory 808 and/or the secondary memory 810) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 800 may also include a communications interface 824. The communications interface 824 may be configured to allow software and data to be transferred between the computer system 800 and external devices. Exemplary communications interfaces 824 may include a modem, a network interface (e.g., an Ethernet card), a communications port, a PCMCIA slot and card, etc. Software and data transferred via the communications interface 824 may be in the form of signals, which may be electronic, electromagnetic, optical, or other signals as will be apparent to persons having skill in the relevant art. The signals may travel via a communications path 826, which may be configured to carry the signals and may be implemented using wire, cable, fiber optics, a phone line, a cellular phone link, a radio frequency link, etc.

The computer system 800 may further include a display interface 802. The display interface 802 may be configured to allow data to be transferred between the computer system 800 and external display 830. Exemplary display interfaces 802 may include high-definition multimedia interface (HDMI), digital visual interface (DVI), video graphics array (VGA), etc. The display 830 may be any suitable type of display for displaying data transmitted via the display interface 802 of the computer system 800, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 808 and secondary memory 810, which may be memory semiconductors (e.g., DRAMs, etc.). These computer program products may be means for providing software to the computer system 800. Computer programs (e.g., computer control logic) may be stored in the main memory 808 and/or the secondary memory 810. Computer programs may also be received via the communications interface 824. Such computer programs, when executed, may enable computer system 800 to implement the present methods as discussed herein. In particular, the computer programs, when executed, may enable processor device 804 to implement the methods illustrated by FIGS. 4, 6, and 7, as discussed herein. Accordingly, such computer programs may represent controllers of the computer system 800. Where the present disclosure is implemented using software, the software may be stored in a computer program product and loaded into the computer system 800 using the removable storage drive 814, interface 820, and hard disk drive 812, or communications interface 824.

Techniques consistent with the present disclosure provide, among other features, systems and methods for identifying consumer travel paths and trip patterns and predicting future travel paths. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for generating consumer travel paths based on transaction history, comprising:
storing, in a transaction database, transaction data for a plurality of payment transactions, wherein the transaction data includes at least a geographic location and transaction time and/or date associated with the respective payment transaction and an consumer identifier associated with a consumer involved in the respective payment transaction;
receiving, by a receiving device, a specific geographic area for which consumer movement is requested;
identifying, by a processing device, a payment transaction set for each of one or more consumers, wherein each payment transaction set includes transaction data for a set of payment transactions that include a common consumer identifier, a geographic location corresponding to the received specific geographic area, and a transaction time and/or date included within a predetermined period of time;
generating, by the processing device, a travel path for each payment transaction set that identifies movement of a consumer associated with the common consumer identifier for the respective payment transaction set, wherein the travel path is based on at least the geographic location and transaction time and/or date included in the transaction data for each payment transaction included in the respective payment transaction set; and
predicting, by the processing device, a future travel path for each payment transaction set that predicts future movement of the consumer associated with the common consumer identifier for the respective payment transaction set, wherein the future travel path is based on at least the generated travel path.

2. The method of claim 1, wherein
predicting the future travel path further includes predicting a future geographic location that the consumer associated with the common consumer identifier for the respective payment transaction set is predicted to visit, and
the future geographic location corresponds to a geographic location of a merchant located in the specific geographic area.

3. The method of claim 1, further comprising:
transmitting, by a transmitting device, the predicted future travel path for each payment transaction set.

4. The method of claim 3, wherein the predicted future travel path for each payment transaction set is transmitted to one or more merchants having geographic locations corresponding to the predicted future travel path for each payment transaction set.

5. The method of claim 1, further comprising:
identifying, by the processing device, an optimal location of a merchant within the specific geographic area based on at least the generated travel path and predicted future travel path for each payment transaction set.

6. A method for identifying consumer trip patterns, comprising:
storing, in a transaction database, transaction data for a plurality of payment transactions, wherein the transaction data includes at least a geographic location and transaction time and/or date associated with the respective payment transaction and an consumer identifier associated with a consumer involved in the respective payment transaction;
receiving, by a receiving device, a specific consumer identifier;
identifying, by a processing device, transaction data for a subset of payment transactions, wherein the transaction data for each payment transaction in the subset includes a consumer identifier that corresponds to the received specific consumer identifier;
identifying, by the processing device, a plurality of transaction sets, wherein each transaction set includes transaction data for a payment transaction in the subset of payment transaction where the included transaction time and/or date is within one of a plurality of periods of time;
generating, by the processing device, a travel path for each transaction set that identifies movement of a consumer associated with the specific consumer identifier, wherein the travel path is based on at least the geographic location and transaction time and/or date included in the transaction data for each payment transaction included in the respective transaction set; and
identifying, by the processing device, one or more trip patterns for the consumer associated with the specific consumer identifier, wherein each trip pattern is based on correspondence between the generated travel path and associated period of time for each transaction set.

7. The method of claim 6, further comprising:
transmitting, by a transmitting device, the identified one or more trip patterns.

8. The method of claim 6, further comprising:
classifying, by the processing device, the consumer associated with the specific consumer identifier in at least one of a plurality of consumer classifications based on the identified one or more trip patterns.

9. The method of claim 8, further comprising:
transmitting, by a transmitting device, the at least one consumer classification in which the consumer is classified.

10. The method of claim 8, wherein the plurality of consumer classifications include one or more microsegments.

11. A system for generating consumer travel paths based on transaction history, comprising:
a transaction database configured to store transaction data for a plurality of payment transactions, wherein the transaction data includes at least a geographic location and transaction time and/or date associated with the respective payment transaction and an consumer identifier associated with a consumer involved in the respective payment transaction;
a receiving device configured to receive a specific geographic area for which consumer movement is requested; and
a processing device configured to
identify a payment transaction set for each of one or more consumers, wherein each payment transaction set includes transaction data for a set of payment transactions that include a common consumer identifier, a geographic location corresponding to the received specific geographic area, and a transaction time and/or date included within a predetermined period of time,
generate a travel path for each payment transaction set that identifies movement of a consumer associated with the common consumer identifier for the respective payment transaction set, wherein the travel path is based on at least the geographic location and transaction time and/or date included in the transaction data for each payment transaction included in the respective payment transaction set, and
predict a future travel path for each payment transaction set that predicts future movement of the consumer associated with the common consumer identifier for the respective payment transaction set, wherein the future travel path is based on at least the generated travel path.

12. The system of claim 11, wherein
predicting the future travel path further includes predicting a future geographic location that the consumer associated with the common consumer identifier for the respective payment transaction set is predicted to visit, and
the future geographic location corresponds to a geographic location of a merchant located in the specific geographic area.

13. The system of claim 11, further comprising:
a transmitting device configured to transmit the predicted future travel path for each payment transaction set.

14. The system of claim 13, wherein the predicted future travel path for each payment transaction set is transmitted to one or more merchants having geographic locations corresponding to the predicted future travel path for each payment transaction set.

15. The system of claim 11, wherein the processing device is further configured to identify an optimal location of a merchant within the specific geographic area based on at least the generated travel path and predicted future travel path for each payment transaction set.

16. A system for identifying consumer trip patterns, comprising:
a transaction database configured to store transaction data for a plurality of payment transactions, wherein the transaction data includes at least a geographic location and transaction time and/or date associated with the respective payment transaction and an consumer identifier associated with a consumer involved in the respective payment transaction;
a receiving device configured to receive a specific consumer identifier; and
a processing device configured to
identify transaction data for a subset of payment transactions, wherein the transaction data for each payment transaction in the subset includes a consumer identifier that corresponds to the received specific consumer identifier,
identify a plurality of transaction sets, wherein each transaction set includes transaction data for a payment transaction in the subset of payment transaction where the included transaction time and/or date is within one of a plurality of periods of time,
generate a travel path for each transaction set that identifies movement of a consumer associated with the specific consumer identifier, wherein the travel path is based on at least the geographic location and transaction time and/or date included in the transaction data for each payment transaction included in the respective transaction set, and
identify one or more trip patterns for the consumer associated with the specific consumer identifier, wherein each trip pattern is based on correspondence between the generated travel path and associated period of time for each transaction set.

17. The system of claim 16, further comprising:
a transmitting device configured to transmit the identified one or more trip patterns.

18. The system of claim 16, wherein the processing device is further configured to classify the consumer associated with the specific consumer identifier in at least one of a plurality of consumer classifications based on the identified one or more trip patterns.

19. The system of claim 18, further comprising:
a transmitting device configured to transmit the at least one consumer classification in which the consumer is classified.

20. The system of claim 18, wherein the plurality of consumer classifications include one or more microsegments.
